(19) United States
(12) Patent Application Publication
(10) Pub. No.: US 2025/0290949 A1
(43) Pub. Date: Sep. 18, 2025

(54) Heat Dissipating AFM Probe

(71) Applicant: Bruker Nano, Inc., Santa Barbara, CA (US)

(72) Inventors: Vladimir Zhizhimontov, Goleta, CA (US); Rakesh Poddar, Camarillo, CA (US)

(21) Appl. No.: 19/080,263

(22) Filed: Mar. 14, 2025

Related U.S. Application Data
(60) Provisional application No. 63/565,322, filed on Mar. 14, 2024.

(51) Int. Cl. G01Q 60/38; G01Q 30/10

(52) U.S. Cl. CPC G01Q 60/38; G01Q 30/10

(57) ABSTRACT

A probe assembly for a surface analysis instrument such as an atomic force microscope (AFM), and a corresponding method of operation, that dissipates heat in response to photothermally driving the probe. The heat dissipating probe assemblies include a substrate defining a probe body of the probe assembly, a cantilever of the probe assembly extending from the probe body and having a free end, and wherein at least a portion of the cantilever operates as a heat sink when the probe assembly is actuated with a photothermal laser. The cantilever can be a single diving board type cantilever having a width twice that of the photothermal laser spot, or include one or more heat sink arms. A corresponding method of wafer level batch fabrication is also provided.

### CROSS-REFERENCE TO RELATED APPLICATION

This application claims priority under 35 U.S.C. § 1.119 (e) to U.S. Provisional Patent Application No. 63/565,322, filed Mar. 14, 2024. The subject matter of this application is hereby incorporated by reference in its entirety.

### BACKGROUND OF THE INVENTION

### Field of the Invention

The preferred embodiments are directed to a probe assembly for a metrology instrument and a corresponding method of manufacture, and more particularly, a probe assembly having a cantilever geometry that reduces tip heating during photothermal excitation.

### Description of Related Art

Scanning probe microscopes (SPMs), such as the atomic force microscope (AFM), are devices which use a sharp tip and low forces to characterize the surface of a sample down to atomic dimensions. Generally, the tip of the SPM probe is introduced to the sample surface to detect changes in the characteristics of the sample. By providing relative scanning movement between the tip and the sample, surface characteristic data can be acquired over a particular region of the sample and a corresponding map of the sample can be generated.

A typical AFM system is shown schematically in FIG. 1. An AFM 10 employs a probe device 12 including a probe 14 having a cantilever 15 extending from a base 19. A scanner 24 generates relative motion between the probe 14 and sample 22 while the probe-sample interaction is measured. In this way images or other measurements of the sample can be obtained. Scanner 24 is typically comprised of one or more actuators that usually generate motion in three orthogonal directions (XYZ). Often, scanner 24 is a single integrated unit that includes one or more actuators to move either the sample or the probe in all three axes, for example, a piezoelectric tube actuator. Alternatively, the scanner may be an assembly of multiple separate actuators. Some AFMs separate the scanner into multiple components; for example, an XY scanner that moves the sample and a separate Z-actuator that moves the probe. The instrument is thus capable of creating relative motion between the probe and the sample while measuring the topography or some other surface property of the sample as described, e.g., in Hansma et al. U.S. Pat. No. RE 34,489; Elings et al. U.S. Pat. No. 5,266,801; and Elings et al. U.S. Pat. No. 5,412,980.

In a common configuration, probe 14 is often coupled to an oscillating actuator or drive 16 that is used to drive probe 14 at or near a resonant frequency of cantilever 15. Alternative arrangements measure the deflection, torsion, or other motion of cantilever 15. Probe 14 is often a microfabricated cantilever with an integrated tip 17.

Commonly, an electronic signal is applied from an AC signal source 18 under control of an SPM controller 20 to cause actuator 16 (or alternatively scanner 24) to drive the probe 14 to oscillate. The probe-sample interaction is typically controlled via feedback by controller 20. Notably, actuator 16 may be coupled to the scanner 24 and probe 14 but may be formed integrally with the cantilever 15 of probe 14 as part of a self-actuated cantilever/probe.

Often a selected probe 14 is oscillated and brought into contact with sample 22 as sample characteristics are monitored by detecting changes in one or more characteristics of the oscillation of probe 14, as described above. In this regard, a deflection detection apparatus 25 is typically employed to direct a beam towards the backside of probe 14, the beam then being reflected towards a detector 26. As the beam translates across detector 26, appropriate signals are processed at block 28 to, for example, determine RMS deflection and transmit the same to controller 20, which processes the signals to determine changes in the oscillation of probe 14. In general, controller 20 generates control signals to maintain a relative constant interaction between the tip and sample (or deflection of the lever 15), typically to maintain a setpoint characteristic of the oscillation of probe 14. More particularly, controller 20 may include a PI Gain Control block 32 and a High Voltage Amplifier 34 that condition an error signal obtained by comparing, with circuit 30, a signal corresponding to probe deflection caused by tip-sample interaction with a setpoint. For example, controller 20 is often used to maintain the oscillation amplitude at a setpoint value, AS, to insure a generally constant force between the tip and sample. Alternatively, a setpoint phase or frequency may be used.

A workstation 40 is also provided, in the controller 20 and/or in a separate controller or system of connected or stand-alone controllers, that receives the collected data from the controller and manipulates the data obtained during scanning to perform point selection, curve fitting, and distance determining operations.

AFMs may be designed to operate in a variety of modes, including contact mode and oscillating mode. Operation is accomplished by moving either the sample or the probe assembly up and down relatively perpendicular to the surface of the sample in response to a deflection of the cantilever of the probe assembly as it is scanned across the surface. Scanning typically occurs in an “x-y” plane that is at least generally parallel to the surface of the sample, and the vertical movement occurs in the “z” direction that is perpendicular to the x-y plane. Note that many samples have roughness, curvature and tilt that deviate from a flat plane, hence the use of the term “generally parallel.” In this way, the data associated with this vertical motion can be stored and then used to construct an image of the sample surface corresponding to the sample characteristic being measured, e.g., surface topography.

In an AFM, for example, in a mode of operation called contact mode, the microscope typically scans the tip, while keeping the force of the tip on the surface of the sample generally constant. This is accomplished by moving either the sample or the probe assembly up and down relatively perpendicularly to the surface of the sample in response to a deflection of the cantilever of the probe assembly as it is scanned across the surface. In this way, the data associated with this vertical motion can be stored and then used to construct an image of the sample surface corresponding to the sample characteristic being measured, e.g., surface topography. Similarly, in another preferred mode of AFM operation, known as TappingMode™ (TappingMode™ is a trademark owned by the present assignee), the tip is oscillated at or near a resonant frequency of the associated cantilever of the probe. The amplitude or phase of this oscillation is kept constant during scanning using feedback signals, which are generated in response to tip-sample interaction. As in contact mode, these feedback signals are then collected, stored and used as data to characterize the sample.

The deflection of the cantilever in response to the probe tip's interaction with the sample is measured with an extremely sensitive deflection detector, most often an optical lever system. In such optical systems, a lens is employed to focus electromagnetic energy of a coherent light source such as a laser or super luminescent diode (SLD), from a source typically placed overhead of the cantilever, onto the back side of the cantilever. The backside of the lever (the side opposite the tip) is reflective (for example, using metallization during fabrication) so that the beam may be reflected therefrom towards a photodetector. The translation of the beam across the detector during operation provides a measure of the deflection of the lever, which again is indicative of one or more sample characteristics.

Photothermal excitation is a technique that uses a coherent light source to directly excite the cantilever oscillation, resonance or off-resonance, providing advantages for certain modes of AFM operation. With a piezo drive, the AFM mechanically vibrates or shakes the probe assembly, thereby often exciting unwanted mechanical resonances that compromise the probe response. With a photothermal drive power from a coherent light source is modulated to excite probe oscillation in, for example, TappingMode™. Typically, metal coatings deposited on the cantilever provide a bi-material effect; more particularly, differential thermal expansion caused by the excitation photothermal coherent light source on the metal coating induces mechanical stress in the cantilever, provoking cantilever oscillation. This method of excitation can thereby be employed in a more stable and efficient way given that the photothermal energy is localized to only the cantilever of the probe assembly. Heat conducts typically from the impingement spot of near the base the probe assembly toward the tip. This is particularly a problem when operating the AFM in ambient air. One significant drawback with standard probes is that they are susceptible to the adverse effects of heat near the tip under photothermal excitation. For several types of AFM measurements, a heated tip is undesirable, especially when measuring samples with low melting or softening temperature.

Different solutions have been tried to attempt to accommodate this issue. Most AFM designers and users try to precisely locate the position of the photothermal laser spot, typically near the base of the cantilever. This can be somewhat effective, but is not particularly efficient and provides little relief from this drawback when using ultra-short cantilevers.

Heating depends only on absorbed power, which is proportional to a product of light intensity and the coefficient of absorption. So others have tried unique probe designs and microfabrication techniques to facilitate heat dissipation. However, known solutions are not readily manufacturable and increase the cost substantially as individual probes have to be processed to get workable, yet less than ideal, results, e.g., using micromanipulators.

In view of the above, the field of scanning probe microscopy was in need of a probe assembly that can accommodate photothermal excitation, even with a high power laser, without excessive heating of the tip. Imaging soft samples with a greater excitation amplitude than previously possible was desired. Preferably, probe assemblies resistant to tip heating would be manufacturable at the wafer level for efficient bulk production.

Note that “SPM” and the acronyms for the specific types of SPMs, may be used herein to refer to either the microscope apparatus, or the associated technique, e.g., “atomic force microscopy.”

### SUMMARY OF THE INVENTION

The preferred embodiments overcome the drawbacks of prior solutions by providing a probe assembly design and corresponding method of manufacture that provides a heat sink path away from the tip. Keeping the free end of the probe assembly, including the tip if present, at about room temperature is possible. As a result, photothermal actuation can be employed to image soft samples such as C18H38 which melts at 28° C. or other soft polymers which can soften with the application of heat. The design also allows the use of a high power coherent light source for greater excitation amplitude of the cantilever and is batch manufacturable.

According to a first aspect of the preferred embodiment, a probe assembly for a surface analysis instrument includes a substrate defining a probe body of the probe assembly. A cantilever of the probe assembly extends from the probe body and has a free end. At least a portion of the probe assembly operates as a heat dissipating element when the probe assembly is actuated with a photothermal coherent light source (e.g., laser) that directs photothermal energy at a spot on the cantilever so as to reduce heating the free end of the probe assembly with the photothermal energy. More particularly, the cantilever may operate as a heat sink when the probe assembly is actuated/driven with a photothermal laser that directs photothermal energy at a spot on the cantilever. A lateral thermal gradient between the photothermal laser spot and the free end is thereby created to allow imaging of even soft samples.

According to a further aspect of the preferred embodiment, the portion includes at least one heat sink leg extending from a photothermally actuated portion of the cantilever preferably at or about the free or distal end to the probe body. The photothermally actuated portion includes the free or distal end, which may include a tip.

In another aspect of this embodiment, the at least one heat sink leg is at least two heat sink legs laterally separated from the photothermally actuated portion. The heat sink leg and the actuated portion may be connected with at least one bridge element for improved heat dissipating efficiency.

According to a still further aspect of the preferred embodiment, the photothermally actuated portion of the cantilever is one of a group of triangular shaped, diving board shaped and paddle shaped. Notably, the cantilever may be coated in Aluminum.

According to an alternate aspect of the preferred embodiment, a width of the cantilever is at least 1.5 times a width of the photothermal coherent light beam spot.

In another embodiment, a method of operating a surface analysis instrument includes providing a probe having a base and a cantilever with proximal and free/distal ends and extending from the base, the probe having heat dissipating geometry. The method then initiates a mode of operation of the surface analysis instrument and directs photothermal energy at the proximal end at a photothermal laser spot to drive the probe according to the mode of operation. During operation of the surface analysis instrument, heat from the photothermal energy is directed away from the free end based on the heat dissipating geometry.

According to another aspect of this embodiment, the heat dissipating geometry includes at least one heat sink leg extending substantially parallel to a photothermally actuated portion of the cantilever.

In another aspect of this embodiment, a width of the cantilever is at least one and a half times a width of the photothermal light beam spot.

According to a method of fabricating a heat dissipating probe assembly for a surface analysis instrument the method includes microfabricating an array of the heat dissipating probe assemblies having a heat dissipating geometry. The heat dissipating probe assemblies include a substrate defining a probe body of the probe assembly, a cantilever of the probe assembly extending from the probe body and having a free end, and wherein at least a portion of the cantilever operates as a heat dissipating element (e.g., one or more heat sink portions) when the probe assembly is actuated with a photothermal laser.

In another aspect of this embodiment, the heat dissipating geometry includes forming the heat sink portion as at least one heat sink leg extending substantially parallel to a photothermally actuated portion of the cantilever

These and other objects, features, and advantages of the invention will become apparent to those skilled in the art from the following detailed description and the accompanying drawings. It should be understood, however, that the detailed description and specific examples, while indicating preferred embodiments of the present invention, are given by way of illustration and not of limitation. Many changes and modifications may be made within the scope of the present invention without departing from the spirit thereof, and the invention includes all such modifications.

### BRIEF DESCRIPTION OF THE DRAWINGS

A preferred exemplary embodiment of the invention is illustrated in the accompanying drawings in which like reference numerals represent like parts throughout, and in which:

FIG. 1 is a schematic illustration of a Prior Art atomic force microscope;

FIG. 2 is a schematic isometric view of a cantilever with heat sink arms extending substantially parallel to the thermally actuated cantilever portion supporting the tip, according to a preferred embodiment;

FIG. 3 is a schematic back side view of a probe assembly of a preferred embodiment employing a cantilever similar to that shown in FIG. 1;

FIG. 4 is a schematic back side view of a probe assembly of another preferred embodiment where the cantilever geometry is the commonly used rectangular shape, but the width of the cantilever is at least twice the width of the photothermal light beam spot for providing sufficient surface area to dissipate the heat to the probe body;

FIGS. 5A-5H illustrate a series of schematic top views of different embodiments of a heat dissipating cantilever, each including a unique heat sink geometry; and

FIG. 6 is a flow chart illustrating a method of operating an AFM employing a probe according to the preferred embodiments.

### DETAILED DESCRIPTION OF THE PREFERRED EMBODIMENTS

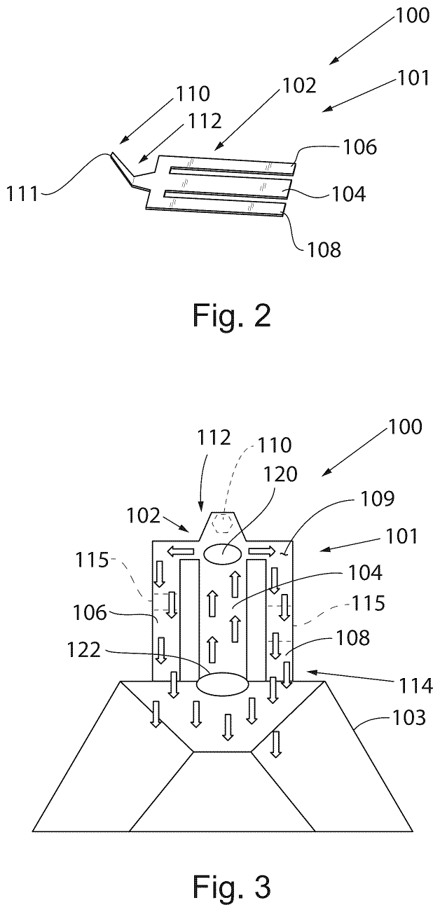

Turning initially to FIG. 2, a schematic heat dissipating probe assembly 100 having a heat dissipating element for an atomic force microscope (AFM) fabricated according to the preferred embodiments is shown. In this case, probe 101 has a heat dissipating geometry that includes a cantilever 102 having a center diving board portion 104 that operates as the AFM sensing cantilever, flanked by two heat sink structures/portions or fingers 106, 108 extending and spaced from center portion 104. Heat sink portions are shown parallel to center diving board 104 but may be spaced from and extend at an angle to diving board 104. Dimensions, including length, width and thickness of sensing cantilever 102 define probe resonance and stiffness (application specific). Thickness and materials of the heat sink arm can be different than those of the sensing cantilever. In one example, a cantilever length of 17 um, width of 5 μm and thickness of 150 nm and heat sink length of 15 μm with 3 um width and 2 um spacing provides resonance of 1.1 MHz and stiffness of 0.4 N/m. Typically, cantilever 102 including AFM sensing cantilever 104 and heat sink portions 106, 108 are silicon nitride, however, can be any suitable material which can be micromachined to form AFM cantilevers with high resonance, e.g. silicon oxide. Known semiconductor fabrication techniques using a silicon wafer are employed to batch produce lever 102 and a tip 110 extending from a free or distal end 112 of lever of the heat dissipating probe device. In operation, it is heat sink portions 106, 108 that divert heat away from center portion 104, and more particularly tip 110 supported at free end 112 thereof, and toward the probe body.

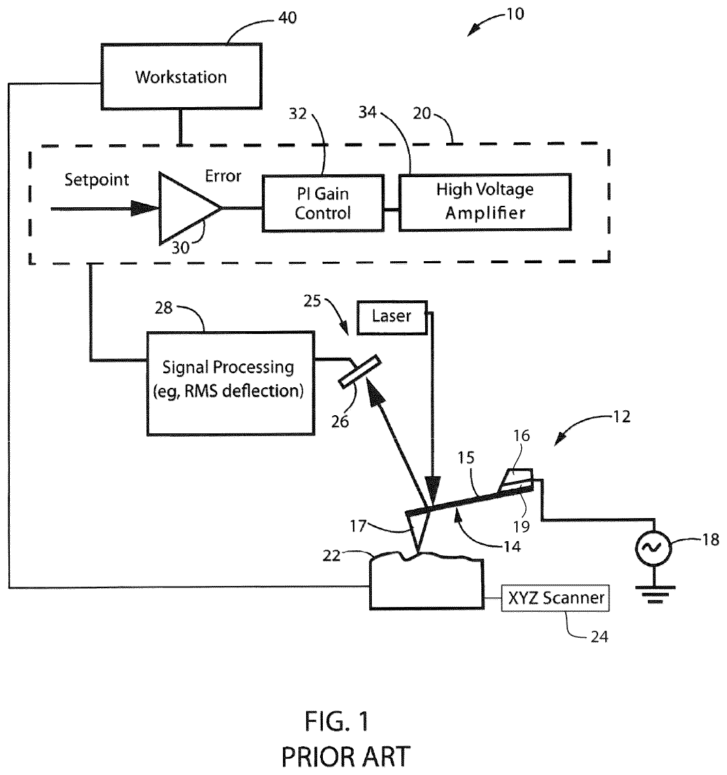

Turning to FIG. 3, the backside of a probe assembly 100 including probe 101 extending from a probe body or base 103 at a proximal end 114, typically from a silicon substrate (described further below), is schematically illustrated. Cantilever 102 includes a free end with free end 112 from which tip 110 is supported. Tip 110 has an apex 111 that interacts with the surface of a sample when imaging with the AFM. Cantilever 102 includes center AFM sensing cantilever 104 with two heat sink portions 106, 108 extending substantially parallel thereto. Coherent light source (e.g., laser) spot 120 shown near distal end 112 of cantilever 102 of probe 101 is the laser used to detect beam deflection using a conventional optical beam-bounce technique employing a quadrant photodetector (126 in FIG. 1).

When employing a photothermal coherent light source to drive the probe, the source (not shown) directs a beam at about proximal end 114 of the center of the probe at AFM sensing cantilever 104. Cantilever 102 includes metal coating 109 (e.g., aluminum) to create a bi-material structure where materials have different coefficient of temperature expansion (CTE). Gold coating has higher light absorption in the visible range, and aluminum higher light absorption in the near infrared range. Use of different metal coating allows maximizing efficiency of the photothermal drive with a coherent source

Actuation of probe assembly 100 in this way, for example to drive TappingMode™, heats the probe assembly. That heat has a tendency to travel up sensing portion 104 of cantilever 102, as shown by the arrows, toward free end 112 of probe 101. Normally, this can cause undesired tip heating. In the present preferred embodiments, however, the heat is diverted to the two heat sink fingers 106, 108 of cantilever 102. At least a portion of the heat continues to travel away from tip 110 and back toward base or probe body 103 of probe assembly 100. Probe body 102, advantageously, also acts as a heat sink further alleviating the adverse effects of unwanted tip heating. It is important to note that heat sinks impede resonance of the cantilever due to added mass and should be considered in designing the AFM probe system with such heat sinks.

As seen is FIG. 3, the photothermally actuated sensing portion 104 of cantilever 102 is physically separated from the heat sink structures 106, 108. These structures, since they are not physically connected and do not come in contact with photothermal laser, provide a higher thermal gradient with respect to AFM sensing cantilever 104 without the heat sink. As a result, considerable part of the heat near the tip will be redirected to the base portion or heat sink body 103, i.e., probe body 103 via heat sink structures 106, 108, thereby keeping the tip at a low temperature—preferably close to ambient temperature.

Employing this design, photothermal actuation is possible when scanning/imaging soft samples such as C18H38, which melts at 28° C., or other soft polymers which will soften with the application of heat. The design also allows the use of a high power laser at its maximum limits such as using full 10 mW laser available in most commercial AFM systems for greater excitation amplitude of the cantilever without substantial tip heating which is needed to measure softer samples. Probe assemblies made in this way are cost-effective, batch manufacturable utilizing high volume semiconductor fabrication techniques. Probes may employ silicon nitride (SiN) cantilevers using standard MEMS processing. However, the cantilevers can be silicon, silicon oxide or any other suitable material. The free end of the cantilevers typically extends at about 54.7° and act as the base of the tip. Sharp tips for AFM imaging are deposited using EBD processing. All processing is therefore done at the wafer level for improved performance, lower cost, and consistent user experience.

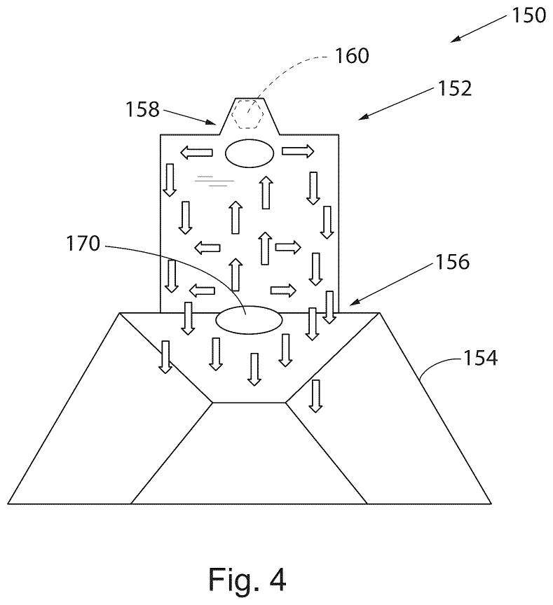

Turning next to FIG. 4, an alternate probe design with similar performance and benefits is illustrated from its backside. More particularly, a probe assembly 150 includes a cantilever 152 extending from a base portion or body 154 (probe anchor) at a proximal end 156 of cantilever 152. A free end 158 of lever 152 supports a tip 160. Rather than an AFM sensing cantilever portion of FIG. 3, cantilever 152 has a solid body with dimensions carefully selected for maximum heat dissipation.

In this case, cantilever 152 is made wider than the photothermal laser spot 170. This will help in creating thermal gradient between a center portion 162 of cantilever 152 and the adjacent cantilever edge portions 164, 166, resulting is heat moving towards the edge of the cantilever and to the heat sink body, i.e., large probe body 154.

However, the temperature gradient will be small and most of the heat will still be directed towards tip 160 (upwards in FIG. 4) due to the larger temperature gradient between tip 160 and the laser spot location. This architecture will help reduce the temperature at the tip but is not very efficient. The efficiency of heat sink is proportional to width and the length of the cantilever which puts additional constraint on the cantilever resonance and stiffness. Width W2 of cantilever is selected to be substantially greater than width W1 of the photothermal laser spot 170. In a preferred embodiment, width W2 is at least two (2) times that of W1 to provide useful heat dissipation.

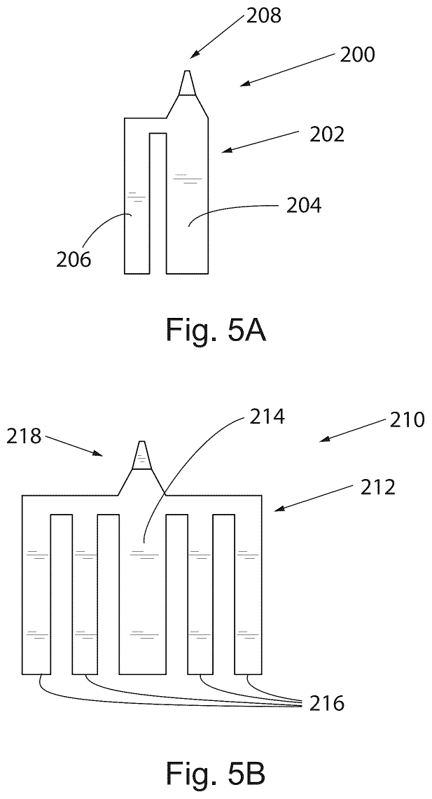

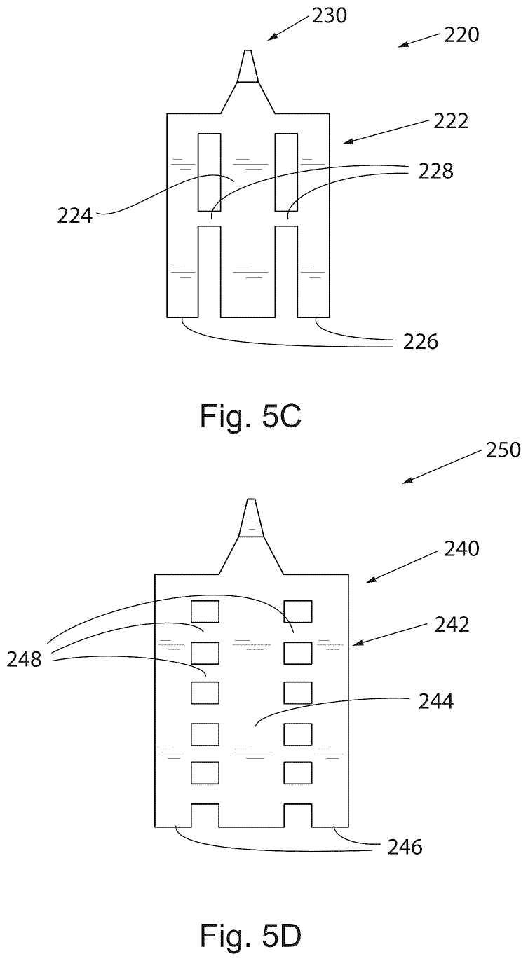

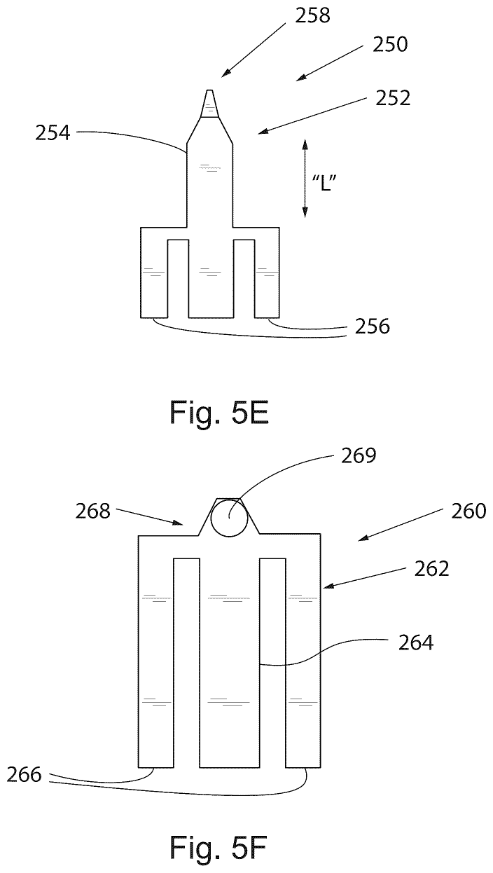

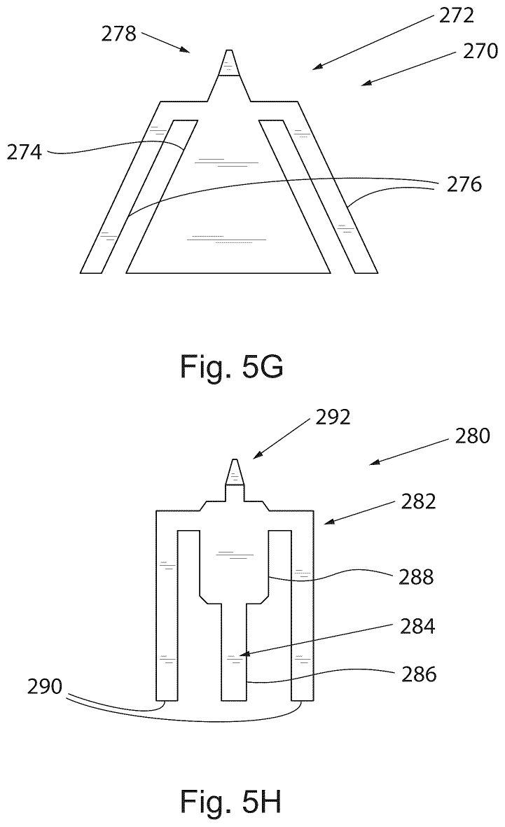

With reference to FIGS. 5A-5H, a number of alternate cantilever geometries of the heat dissipating probe of the preferred embodiments are illustrated. Each geometry provides advantages for different types of measurements on different types of samples using a photothermal drive, though some may be more complex to produce, as described further below. In FIGS. 5A and 5B, cantilever schemes with single or multiple heat sink paths arc shown. In FIG. 5A, a probe 200 including a cantilever 202 includes an AFM sensing lever 204 and a parallel heat sink arm 206 spaced therefrom to pull heat away from the distal tip end 208 of probe 200. A single heat sink 206 for instance may all that is needed when using a low power photothermal beam, with the sink place of the side opposite the scanning direction to keep heat away from the region of the sample to be imaged. In FIG. 5B, a probe 210 including a cantilever 212 includes an AFM sensing lever 214 and a plurality of parallel heat sink arms 216 flanked on either side of sensing lever 214 and spaced therefrom to pull heat about from the free tip end 208 of probe 200. In this case, heat sink arms 216 are provided to collect a greater amount of heat than any of the previous embodiments (i.e., for those experiments requiring a higher power photothermal drive laser or when imaging a more sensitive sample).

Turning to FIGS. 5C and 5D, probe geometries similar to the embodiment of FIG. 3 are shown, with bridge sections connecting the heat sink portions to the AFM sensing cantilever. In FIG. 5C, a probe 220 including a cantilever 222 includes an AFM sensing lever 224 and parallel heat sink arms 226 spaced therefrom to pull heat away from the free/distal tip end 250 of probe 220. In this case, bridge portions 228 connect sensing lever 224 and heat sink arms 226. These bridge portions add mass and alter resonance but can provide additional heat sink help. FIG. 5D illustrates a similar design with a probe 240 defining a cantilever 242 that includes an AFM sensing lever 244 and a parallel heat sink arms 246 spaced therefrom to pull heat away from the free tip end 250 of probe 240. Here, a plurality of bridge portions 248 connect sensing lever 244 and heat sink arms 246. These bridge portions add mass and alter resonance but can provide even greater dissipation of the heat introduced to the AFM by the photothermal drive.

Next, with reference to FIG. 5E, a probe 250 including a cantilever 252 is illustrated. In this case, cantilever 252 includes heat sink legs 256 parallel to sensing cantilever 254 but they are shorter and disposed further away from free/distal end 258 of probe 260 supporting the tip. In this way, heat dissipation may not be as great with short high frequency levers (e.g., less than 20 microns) as in earlier embodiments, but the heat pulled by the heat sink is advantageously kept further away from free tip end 258. And for longer levers, efficiency of heat dissipation may be better. In sum, heat sink legs may be any length and positioned at different locations to accommodate particular measurements and samples.

In FIG. 5F, a cantilever scheme employing at least one heat sink element accommodates different tip geometries, including pyramidal, cylindrical, conical, or protruding at an angle of, for example, 54.7 degrees, or any other angle. Such tips 269 are defined by way of deposition, etching or milling, and may be disposed on top of another tip having low thermal conductivity. A probe 260 similar to probe of FIG. 3 includes a cantilever 262 with an AFM sensing lever 264 and having heat sink arms 266 parallel to sensing lever 264. Free end 268 of cantilever 262 accommodates a tip 269 having any of several types of tip geometries. This embodiment also envisions different types of tip materials such as any of a group including silicon, silicon nitride, silicon carbide, silicon oxide, any metal or its alloy, carbon or any material with low thermal conductivity such as glass.

FIGS. 5G and 5H illustrate cantilever schemes employing a heat sink such that the cantilever shape could be triangular, paddle shaped or any other shape connected to the probe body providing a heat sink path. The heat sink path can be parallel to the cantilever or defined at an angle. As shown in FIG. 5G, a probe 270 includes a cantilever 272 having a triangular AFM sensing lever 274 and heat sink arms 276 extending substantially parallel to opposite edges of sensing lever 274. A free end 278 supports the probe tip. Turning to FIG. 5H, a probe 280 includes a cantilever 282 having a paddle AFM sensing lever 284 and heat sink arms 290 extending substantially parallel thereto. In this case, sensing lever 284 includes a first elongate portion 286 attached at a first end to a base (not shown) of the probe assembly and an opposite end that terminates in a paddle portion 288 having greater width than portion 286. A distal end 292 supports the probe tip. Similar to the previous embodiment, these designs also contemplate an array of cantilever materials such silicon, silicon nitride, silicon oxide, any metal or its alloy, polymeric materials. Moreover, the bi-material probe cantilever can be coated with heat absorbing materials such as metal (gold, aluminum, etc.) or its alloys, carbon (graphite, diamond) or any polymeric material either locally at one or more parts of the cantilever, or across the entire length of the cantilever, on only one side or both sides. At least two layers/two materials that yield different coefficients of thermal expansion.

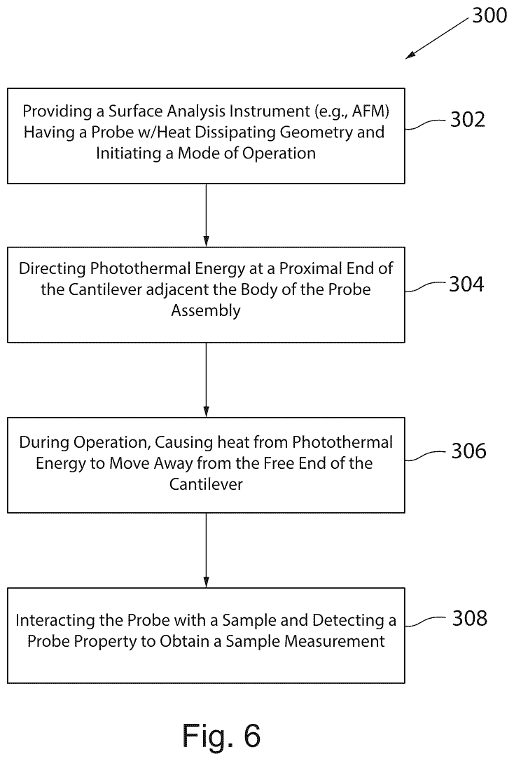

In FIG. 6, a method 300 of operating a probe-based instrument such as an AFM using a heat dissipating probe according to any of the above embodiments is shown. In Step 302, an operating mode is initiated in an AFM employing one or more probes having a heat dissipating geometry. To drive the probe, energy from a photothermal source is directed toward a proximal end of the cantilever where it extends from the probe body in Step 304. Next, during operation in Step 306, heat is directed away from the tip or free end of the cantilever (which may or may not have a tip depending on the measurement) via the heat dissipating geometry of the probe. Again, this could be accomplished in several ways, including fabrication of the probe with heat sink arms, making the width of the lever two times that of the width of the laser spot, etc. (See above) Finally, the method includes interacting the probe with a sample and detecting a probe property to obtain the desired AFM measurement in Step 308.

Photothermal energy is provided using photothermal excitation mechanism such as a high frequency modulated coherent light source. Using such a source, the heat transfer to the free end of the probe, which may include a tip, is minimized. Again, probe design matters; for example, this heat transfer can be controlled by making the cantilever wider such that the width of the cantilever is at least two (2) times the width of the photothermal laser spot.

Although the best mode contemplated by the inventors of carrying out the present invention is disclosed above, practice of the present invention is not limited thereto. It will be manifest that various additions, modifications and rearrangements of the features of the present invention may be made without deviating from the spirit and scope of the underlying inventive concept. For example, other embodiments regarding the number of heat sink paths, location, size, material etc. are contemplated. The heat sink path can be made of the same material as the probe/cantilever or can be made of different materials with higher thermal conductivity for more efficient heat sink properties. In addition, one or more gaps in the coating on the sensing portion (e.g., cantilever) may be provided to tune the heat sink. Referring, for example, to FIG. 3. In this case, coating 109 may alternately be disposed so as to include one or more gaps 115 in coating 109. This is preferably done with selective photolithography to strategically pattern the metal coating to tune the heat sink. A variety of coatings (placement/size) are contemplated. For example, the metal layer thickness of the heat sink arm can be thicker than the metal layer thickness of the sensing cantilever to increase efficiency of the heat sink.

We claim:

1. A probe assembly for a surface analysis instrument, the probe assembly including:
a substrate defining a probe body of the probe assembly;
a cantilever of the probe assembly extending from the probe body and having a free end; and
wherein at least a portion of the probe assembly operates as a heat dissipating element when the probe assembly is actuated with a photothermal coherent light source that directs photothermal energy at a spot on the cantilever so as to reduce heating the free end of the probe assembly with the photothermal energy.

2. The probe assembly of claim 1, wherein the portion includes at least one heat sink leg extending adjacent to a photothermally actuated portion of the cantilever, wherein the photothermally actuated portion includes the free end.

3. The probe assembly of claim 2, wherein the heat sink leg and the actuated portion are connected with at least one bridge element.

4. The probe assembly of claim 2, wherein the at least one heat sink leg is at least two heat sink legs laterally separated from the photothermally actuated portion.

5. The probe assembly of claim 2, wherein the thermally actuated portion is one of a group including triangular shaped, diving board shaped and paddle shaped.

6. The probe assembly of claim 1, wherein at least a part of the cantilever is coated with a heat absorbing material that dissipates heat generated by the photothermal energy.

7. The probe assembly of claim 6, wherein the heat absorbing material is disposed on at least two portions of the cantilever, the portions being separated by a gap.

8. The probe assembly of claim 6, wherein the heat absorbing material is at least one of a group including metal, a metal alloy or a polymeric material.

9. The probe assembly of claim 1, wherein a width of the cantilever is at least one and a half (1.5) times a width of the photothermal energy spot, and the free end supports a tip.

10. The probe assembly of claim 1, wherein the heat dissipating element includes a base portion and at least one arm, and wherein a thickness of the base material is tuned based on a resonant frequency or stiffness of the probe.

11. A method of operating a surface analysis instrument, the method including:
providing a probe assembly having a base and a cantilever with proximal and free ends and extending from the base;
initiating a mode of operation of the surface analysis instrument;
directing photothermal energy at the proximal end at a photothermal energy spot to drive the probe according to the mode of operation; and
wherein, during operation of the surface analysis instrument, the probe assembly dissipates heat from the photothermal energy to reduce heating of the free end by the photothermal energy.

12. The method of claim 11, wherein the probe assembly has a heat dissipating geometry that directs heat from the photothermal energy away from the free end.

13. The method of claim 12, wherein the heat dissipating geometry includes at least one heat sink leg extending substantially parallel to a photothermally actuated portion of the cantilever.

14. The method of claim 13, wherein the heat sink leg and the actuated portion are connected with a bridge element.

15. The method of claim 13, wherein the heat sink leg includes at least two heat sink legs, and the heat sink legs and the actuated portion are connected with a plurality of equally spaced bridge elements.

16. The method claim 11, wherein the surface analysis instrument is an AFM, the free end supports a tip, and the mode of operation is one of TappingMode™ and PeakForce™ Tapping Mode.

17. The method of claim 11, wherein the photothermal energy is provided by a high frequency laser, and the probe is coated in a heat absorbing material to dissipate the heat from the photothermal energy.

18. The method of claim 11, wherein a width of the cantilever is at least two times a width of the photothermal electromagnetic energy beam spot.

19. A method of manufacturing a heat dissipating probe assembly for a surface analysis instrument, the method including:
microfabricating an array of the heat dissipating probe assemblies; and
wherein the heat dissipating probe assemblies include:
a substrate defining a probe body of the probe assembly, a cantilever of the probe assembly extending from the probe body and having a free end, and wherein at least a portion of the probe assemblies operates as a heat dissipating element when the probe assembly is actuated with a photothermal laser.

20. The method of claim 19, wherein the heat dissipating element is a heat dissipating geometry, and wherein the geometry includes forming at least one heat sink leg extending adjacent to a photothermally actuated portion of the cantilever.

21. The method of claim 19, wherein at least a part of the cantilever is coated in a heat absorbing material that dissipates heat generated by the photothermal laser, wherein the heat absorbing material is at least one of a group including gold, platinum, aluminum, graphite, diamond and a polymeric material.
